(19) United States
(12) Patent Application Publication
(10) Pub. No.: US 2009/0170505 A1
(43) Pub. Date: Jul. 2, 2009

(54) Radiation relay process and apparatus

(75) Inventors: Lawrence J. Harpring, North Augusta, SC (US); Frank M. Heckendorn, Aiken, SC (US)

Correspondence Address: J. BENNETT MULLINAX, LLC, P. O. BOX 26029, GREENVILLE, SC, 29616-1029, US

(73) Assignee: Washington Savannah River Co LLC, Aiken, SC (US)

(21) Appl. No.: 11/986,141

(22) Filed: Nov. 19, 2007

Related U.S. Application Data
(60) Provisional application No. 60/859,836, filed on Nov. 17, 2006.

(51) Int. Cl. H04W 4/00; G01J 3/00

(52) U.S. Cl. 455/427; 356/300

(57) ABSTRACT

A process and apparatus is provided for the transmission of radionuclide spectral information from a remote location. The process facilitates the use of a handheld radiation detector to detect a spectrum of radiation from a radiation source such as a cargo ship at sea. The process facilitates the downloading of information to a computer such as a PDA. The PDA is configured to allow communication with a satellite phone that transmits the stored spectrum to an evaluation center for further analysis and positive identification. Once identified, the results can be relayed to the remote location for appropriate action.

### RELATED APPLICATION

This application claims the benefit of U.S. Provisional Application having Ser. No. 60/859,836 filed on Nov. 17, 2006. The above referenced application is incorporated herein by reference for all purposes.

### STATEMENT AS TO RIGHTS TO INVENTIONS MADE UNDER FEDERALLY SPONSORED RESEARCH AND DEVELOPMENT

This invention was made with Government support under Contract No. DE-AC0996-SR18500 awarded by the United States Department of Energy. The Government has certain rights in the invention.

### FIELD OF THE INVENTION

The field of the invention is directed towards an apparatus and process for the transmission of radionuclide spectral information from a remote location, such as offshore operations, to an evaluation center.

### BACKGROUND OF THE INVENTION

Cargo shipments inbound to a country's ports are subject to routine ship inspections. With respect to the United States, the U.S. Coast Guard may conduct ship inspections up to 200 miles from port using handheld isotope identifiers. At times, an isotope spectrum is detected that cannot be identified using onboard equipment and personnel. In such instances, there may be a significant delay in clearing the ship and cargo shipment for entry into U.S. waters. Such delays are costly to the shipping company, the owners/customers of the cargo, and are a poor use of Coast Guard resources. Accordingly, there remains room for improvement in the monitoring and identification process.

### SUMMARY OF THE INVENTION

It is at least one aspect of the present invention to provide for a handheld computer and process which can collect isotope spectrum data and then transmit the date wirelessly via satellite or cellular phone to a shore based facility for further analysis. The analysis allows a more rapid determination as to isotope identification and prevents needless and costly delays in quarantining a shipment or vessel.

It is a further aspect of at least one of the present embodiments of the invention to provide a process and apparatus which uses a handheld computer such as a PDA which is in operative communication with at least one of either a cellular phone or a satellite phone and which is adaptive for downloading to the PDA a radiation spectra from a commercial radiation detector and then transmitting the data via a satellite or cellular phone to an evaluation center.

It is still a further and more particular aspect of at least one of the present embodiments of the invention to provide a process for analyzing a radiation spectrum from a remote location comprising the steps of: performing a radiation scan using a radiation detector; storing the radiation scan in a retrievable data file format; transferring said stored data format of the radiation spectra to a handheld computer such as a PDA; optionally repeating the file data transfer step with additional radiation detectors; transferring files from the handheld computer via a satellite or cell phone to an evaluation center; conducting additional analysis of the transferred spectra at the evaluation center so as to achieve an identification of a radiation source; and, communicating the identification of the spectrum to the remote location.

These and other features, aspects, and advantages of the present invention will become better understood with reference to the following description.

### DESCRIPTION OF THE PREFERRED EMBODIMENT

Reference will now be made in detail to the embodiments of the invention, one or more examples of which are set forth below. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used on another embodiment to yield a still further embodiment. Thus, it is intended that the present invention cover such modifications and variations as come within the scope of the appended claims and their equivalents. Other objects, features, and aspects of the present invention are disclosed in the following detailed description. It is to be understood by one of ordinary skill in the art that the present discussion is a description of exemplary embodiments only and is not intended as limiting the broader aspects of the present invention, which broader aspects are embodied in the exemplary constructions.

### Introduction

Department of Homeland Security (DHS) organizations, such as the U.S. Coast Guard and U.S. Customs and Border Protection (CBP), frequently use radiation detection instruments (such as Target Instruments' identiFINDER™ or identiFINDER-U™ (Oak Ridge, Tenn.) in remote locations. Frequently, the use of radiation detection instruments yields data that is not readily interpretable to the instrument operator. For instance, if there are mixed spectra of isotopes detected simultaneously, a more detailed analysis is needed in order to ascertain the true nature, and hence potential threat, of the spectra. In addition, spectra which are weak may require additional analysis in order to separate out the signal identity from background radiation. The additional analysis may require hardware or software that is beyond the capabilities of field deployable instrumentation. In addition, the expertise needed to evaluate such data is beyond the normal training and skill level of CBP inspectors.

Heretofore, the inability to make an immediate onboard analysis of a radiation signal of a cargo ship resulted in costly delays as the ship was escorted into position to physically transfer the saved files to a separate location for further study and analysis. The attendant delays associated with the physical transfer could result in delays of several days duration in which the cargo ship is detained. The delays also consume valuable CBP personnel and equipment who must maintain a provisional quarantine on the vessel and cargo contents.

The current Radiation Relay apparatus and process (RadRelay™, Washington Savannah River Company LLC, Aiken, S.C.) has demonstrated improved capabilities to transmit the instrument data to CBP's Laboratories and Scientific Services (LSS) Receiving Station for further analysis. RadRelay™ offers a rugged, lightweight, and portable apparatus that provides a reliable, simple, and fast method of data download and transfer from any remote location to the LSS Receiving Station and/or other evaluation center.

### PARTS LIST

The items below are components that may be used to comprise one embodiment of a RadRelay™ system as designed for use in conjunction with an Iridium Satellite Phone or similar service, or a Cellular Phone service (SIM card).

| Item | Vendor |
|---|---|
| Archer Field PDA PC, # 14802 | Juniper Systems (Logan, UT) |
| 1. Communications Extended Cap, # 15077 | Juniper Systems (Logan, UT) |
| 2. Cigarette Lighter Power Adapter, # 12517 | Juniper Systems (Logan, UT) |
| 3. Extra Stylus, # 14847 | Juniper Systems (Logan, UT) |
| 4. Screen Protector (pkg. of 2), # 14930 | Juniper Systems (Logan, UT) |
| 5. Lexar Platinum 512 MB 40× Secure Digital Card | Lexar (Fremont, CA) |
| 6. Enfora GSM/GPRS Compact Flash Modem, # GSM0110 | Enfora (Richardson, TX) |
| 7. USB-A Female to OTG mini-A Male adapter, #_C-OTG-6I | serioalio.com (Santa Barbara, CA) |
| 8. IDF-U Link Cable (identiFINDER to PDA), # 1000148-T | Thermo Electron (Waltham, MA) |
| 9. Iridium to PDA cable | Iridium Satellite LLC |
| a. Iridium 9505 connector | (Bethesda, MD) |
| b. 3′ 9 conductor cable | |
| c. DB-9 female connector with shell | |
| d. Iridium 9505 auto accessory charger cable | |
| 10. Pelican case, # 1470 w/divider | Pelican (Torrance, CA) |
| 11. Charging system | |
| a. Charger with auto accessory | Mouser Elec. (Mansfield, TX) |
| (12 VDC) and 110 VAC adapter, | |
| b. 2 auto accessory sockets | Mouser Elec.. (Mansfield, TX) |
| 12. Crossfire Client software, # EDL-POS | AppForge/Oracle (Redwood |
| | Shores, CA) |

### PDA Description and Requirements

The present invention (referred to herein as RadRelay™) uses a commercial, rugged PDA called the Archer Field PC made by Juniper Systems. The Archer Field PC was chosen because of the robust design parameters which include: operating temperature of −22 to 122° F.; water and dust proof (IP67); shockproof (can survive multiple drops from 5 ft. onto concrete over the entire operating temperature range); meets MIL-STD-810F for water, humidity, sand and dust, vibration, altitude, shock, low and high temperature, and temperature shock; rugged DB-9 RS-232 connection, USB host (Mini-A) port, USB client (Mini-B) port, Compact Flash and Secure Digital 10 card slots with a water and dust proof cap; user replaceable battery; runs Windows Mobile 5.0 (WM5) operating system.

### Software Description and Requirements

In order to interface the hardware referenced above, a combination of commercially available and custom software components, referenced in the list above, are needed to carry out the RadRelay™ process. The custom software components are required to integrate the hardware along with two commercial software products which are installed on the PDA: Crossfire Client™ by AppForge/Oracle, and vxHpc™ by Cambridge Computer Corp. The RadRelay™ software runs on a Windows Mobile™ 5.0 PDA and was intentionally divided into three independent pieces: The RadRelay™ Main Menu, Spectrum Download Program (SDP), and Transfer Files. The independent capabilities of the system facilitate expansion in the future by adding download programs for other instruments. Also, the file transfer portion is generic and will transfer a number of different file types (e.g. radiation data, sound file, video file, image file, etc.) which increases the versatility with other brands of radiation detection.

RadRelay™ Main Menu: This software allows easy access to the Spectrum Download Program, or the Transfer Files program. It can also be expanded in the future to allow the creation and maintenance of a phone number directory and other administrative items. The written software program is designed to provide a simple, useful interface on the PDA for the various functions outlined here. Such software programming capabilities are well within the skill level for one having ordinary skill in the relevant art and can be easily modified to reflect variations in radiation detectors, control parameters, and layout preferences.

Spectrum Download Program (SDP): This software driven menu was specifically designed to work with Target Instruments or Thermo brands of “identiFINDER-U.™” When the SDP is run, the operator is presented with a choice of two things: “Download Actual Spectrum” and “Download All Stored Spectra.” “Download Actual Spectrum” will retrieve the spectrum that is currently in the identiFINDER-U™'s memory (i.e. the spectrum that was just acquired) and save the spectrum to a disk file on the PDA. “Download All Stored Spectra” will retrieve all spectra that have been saved in the identiFINDER-U™'s flash RAM which can be as many as fifty spectra from each identiFINDER-U™. Each spectrum will receive a unique name based on the serial number of the identiFINDER-U™, and the date and time the spectrum was taken. Each file is then saved in the “data” directory. Multiple identiFINDER-U™s may be consecutively connected to the PDA to have their spectra downloaded and saved to the “data” directory. When either of the download buttons is clicked, the serial number of the identiFINDER-U™ is read and displayed at the bottom of the screen. This confirms that the PDA and the identiFINDER-U™ are communicating. The SDP software needed to carry out the above functions is easily developed by one having ordinary skill in the art. It is envisioned that the simple programming needed for this software may be easily varied and adapted by those having ordinary skill in the art to accommodate a variety of different file formats that may be generated by various commercial radiation detectors.

Transfer Files: This software performs the following functions: dials the phone number of the remote phone; waits for the phone on the other end to pick up and create a connection; once the connection is established, the software transfers all the files in the “data” directory; once all the files are transferred, the software hangs up the connection and exits. If the phone connection is broken during the file transfers, the operator simply has to run Transfer Files again and it will pick up where it left off. No duplicate files will be transmitted. It is important to note that Transfer Files is a very small, easily written program that runs a script that controls the commercial program called vxHpc™.

Before this program is run, a standard Windows program called HyperTerminal must be run (on the remote computer) and setup appropriately so that it is waiting for a data phone call and can handle Zmodem protocol file transfers.

The file transfer protocol software can also be modified to provide additional enhancements which may include prompts and/or pre-selected options to select or enter the phone number to be dialed; provide real time user feedback of transfer progress and remaining time during the dialing file transfer event; providing prompts controlling the selection of some or all files in the “data” directory; allowing the user to select alternative directories; and providing encryption options and software capabilities for use in transferring encrypted data files.

### Satellite & Cellular Phone Description and Requirements

The RadRelay™ apparatus and process is designed to work with Coast Guard standard Iridium satellite phones. However, any satellite phone may be configured to provide the necessary functions. With respect to an individual satellite phone, the following items are useful: RS-232 port, a cable to connect the satellite phone's RS-232 port to the PDA, a satellite phone capable of making data calls, and the proper data call dialing codes. For any given satellite phone, a specialty connector may be required to connect the satellite phone to PDA cable. The construction of the cable connected interfaces between satellite phone and the PDA may be customized for any particular satellite phone and/or PDA. Such customization is well within the skill level of one having ordinary skill in the art.

A cellular phone capability is also useful with RadRelay™. It is possible to integrate the Enfora Compact Flash cellular modem card into RadRelay™ which also allows cellular phone capability.

### LSS Receiving Station Requirements

The RadRelay™ instrument will transfer its spectral information to the Laboratories and Scientific Services (LSS) Receiving Station for further analysis. The LSS or other receiving station must have a computer with appropriate modem and file receiving software up and running and ready to receive the data transfer call from the RadRelay™ unit. Typically, the computer will be running the Windows standard HyperTerminal software. Once the receiving station computer and modem are configured for the appropriate data file, the respective transfer file programs on the PDA will be received on the receiving station computer where additional analysis and/or evaluation can be conducted. Once analyzed, the updated information on isotope identification may then be transmitted back to the detection location where appropriate action may be taken.

While the above described process and exemplary apparatus is described in reference to use by U.S. Coast Guard and Custom officials at sea, the apparatus and process is not limited to that one task. Similar needs may arise for more detailed isotope analysis from handheld detectors used at land based Customs' stations at various border crossings. In addition, identification of isotope sources by Homeland Security and/or military personnel can be conducted anywhere in the world with rapid analysis and/or confirmation of field identified isotopes in a rapid manner. The ability to obtain real time identification and/or verification of an isotope source allows for the more rapid screening of suspect materials.

Although preferred embodiments of the invention have been described using specific terms, devices, and methods, such description is for illustrative purposes only. The words used are words of description rather than of limitation. It is to be understood that changes and variations may be made by those of ordinary skill in the art without departing from the spirit or the scope of the present invention which is set forth in the following claims. In addition, it should be understood that aspects of the various embodiments may be interchanged, both in whole, or in part. Therefore, the spirit and scope of the appended claims should not be limited to the description of the preferred versions contained therein.

1. A process for analyzing a radiation spectrum from a remote location comprising the steps of:
performing a radiation scan using a radiation detector;
storing the radiation scan in a retrievable data file format;
transferring said stored data format of the radiation spectra to a handheld computer;
optionally repeating the file data transfer step with additional radiation detectors;
transferring files from the handheld computer via a satellite phone to an evaluation center;
conducting additional analysis of the transferred spectra at the evaluation center to as to achieve a positive identification of a radiation source; and,
communicating the identification of the radiation spectrum to the remote location.

2. A process for analyzing the radiation spectrum from a remote location comprising the steps of:
performing a radiation scan using a radiation detector;
storing the radiation scan in a retrievable data file format;
transferring said stored data format of the radiation spectra to a personal computer;
optionally repeating the file data transfer step with additional radiation detectors;
transferring files from the personal computer via one of either a satellite phone or a cell phone, to an evaluation center;
conducting additional analysis of the transferred spectra at the evaluation center so as to achieve a positive identification of a radiation source; and,
communicating the identification of the radiation spectrum to the remote location.

3. The process according to claim 1 wherein said step of performing a radiation scan using a radiation detector uses a handheld radiation sensor.

4. The process according to claim 1 wherein said step of transferring said stored data of the radiation spectra to a handheld computer is via a cable connecting the radiation detector with the handheld computer.

5. The process according to claim 1 wherein said step of transferring files to an evaluation center comprises the additional step of encrypting said files prior to transferring said files.

6. The process according to claim 2 wherein said step of transferring files to an evaluation center comprises the additional step of encrypting said files prior to transferring said files.

7. The process according to claim 1 wherein said step of transferring files via satellite phone further comprises the step of physically connecting the handheld computer to a modem for communication with said satellite phone.

8. The process according to claim 2 wherein said step of transferring files via satellite phone further comprises the step of physically connecting the computer to a modem for communication with said satellite phone.

9. The process according to claim 1 wherein said radiation scan is detecting multiple isotopes simultaneously.

10. The process according to claim 2 wherein said radiation scan is detecting multiple isotopes simultaneously.
